(19) United States
(12) Patent Application Publication
(10) Pub. No.: US 2008/0287582 A1
(43) Pub. Date: Nov. 20, 2008

(54) SHAPE MEMORY POLYMER COMPOSITIONS, METHOD OF MANUFACTURE, AND USES THEREOF

(76) Inventor: Robert A. Weiss, Storrs, CT (US)

Correspondence Address: CANTOR COLBURN, LLP, 20 Church Street, 22nd Floor, Hartford, CT, 06103, US

(21) Appl. No.: 12/112,067

(22) Filed: Apr. 30, 2008

Related U.S. Application Data
(60) Provisional application No. 60/926,848, filed on Apr. 30, 2007.

(51) Int. Cl. C08K 5/09

(52) U.S. Cl. 524/322

(57) ABSTRACT

A shape memory composition includes an ionomeric elastomer and a low molecular weight additive that forms crystalline domains in the elastomeric ionomer. The amount of additive is effective to provide crystalline domains of a size and distribution effective to provide shape memory to the composition.

### CROSS REFERENCE TO RELATED APPLICATION

This application claims the benefit of U.S. Provisional Patent Application Ser. No. 60/926,848 filed Apr. 30, 2007, which is fully incorporated herein by reference.

### STATEMENT REGARDING FEDERALLY SPONSORED RESEARCH & DEVELOPMENT

The U.S. Government has certain rights in this invention pursuant to a grant from the Polymer Division of the National Science Foundation (Grant DMR 0304803).

### BACKGROUND OF THE INVENTION

This disclosure relates to shape memory polymer (SMP) compositions and, more particularly to a shape memory polymer networks, as well as methods for the preparation of such compositions and uses thereof.

Shape memory materials are materials that can change their physical conformation when exposed to an external stimulus, such as a change in temperature. Such materials have a permanent shape, but can be reshaped above a critical temperature and fixed into a temporary shape when cooled under stress to below the critical temperature. When reheated above the critical temperature (“T_{c}”, also sometimes called the triggering temperature), the material reverts to the permanent shape. Certain polymers can have shape memory properties. SMPs are particularly useful for applications requiring low modulus materials.

Shape memory is an inherent property of certain polymers that can arise, in part, from rubber elasticity. One example of rubber elasticity occurs when a crosslinked rubber is stretched and deformed several hundred percent, it still retains the memory of its original shape, and will return to that original shape when the external stress is released. The origin of this well-known phenomenon is changes in the conformational entropy of the network chains. This is distinct from the phenomenon of shape memory, which arises when the elastomer is deformed above the critical temperature, T_{c}, frozen into a temporary shape that is stable below T_{c}, and then heated again above T_{c} to recover the original shape. To accomplish this, a second “temporary” or reversible network needs to be formed below T_{c}, but disappear above the softening temperature, T_{c}.

Thus, at least two crosslinked networks are present in the microstructure of the shape memory polymers. A primary network provides permanent crosslinks and the permanent shape of the material. This network is usually composed of covalent bonds, but it may rely on physical bonds (e.g., crystallites, hydrogen bonding, ionic interactions, vitrification, or nanophase separation) if the relaxation times of these “bonds” are sufficiently long such that the bonds behave mechanically as permanent with the timeframe of the use of the material. A second network relies on labile physical bonds, as opposed to covalent bonds, to allow for thermal reversibility of the network. The secondary network is reversible at T_{c}, so that for a temperature greater than T_{c}, the network diminishes or disappears, and the material can be deformed to a new shape. When the material is cooled to below T_{c}, while maintaining the deformation, the physical network reforms into the temporary shape of the material. When reheated above T_{c} in the absence of external stress, the original shape of the material, that is, the permanent (original) shape, is recovered.

In most known shape memory polymers, shape memory is provided by the polymer structure itself, although many applications include fillers and additives to adjust the modulus and/or strength of the material. The permanent networks rely on covalently crosslinked networks or physical networks with sufficiently long relaxation times to remain intact within the characteristic lifetime of the temporary shape. The temporary networks and transitions rely on vitrification, melting of crystalline regions, or the like. Adjusting properties such as modulus and/or T_{c} requires changing the structure of the polymers themselves, and thus considerable effort in polymer design and synthesis.

While the known classes of shape memory polymers are suitable for their intended purposes, there nonetheless remains a need in the art for additional materials with both shape memory and elastomer properties. It would be particularly useful if the properties of the elastomers could be readily and predictably varied.

### BRIEF DESCRIPTION OF THE INVENTION

In accordance with the present disclosure, a shape memory article deformable from a temporary shape to a permanent shape comprises a shape memory composition comprising an ionomeric elastomer, and a low molecular weight additive that forms crystalline domains in the elastomeric ionomer, wherein the amount of additive is effective to provide crystalline domains of a size and distribution effective to provide shape memory to the shape memory composition.

Another embodiment is a method of programming a shape memory article, comprising: heating an article having a first shape and comprising a shape memory composition to a temperature above a shape memory critical temperature of the shape memory composition; wherein the shape memory composition comprises an ionomeric elastomer, and a low molecular weight additive that forms crystalline domains in the elastomeric ionomer, wherein the amount of additive is effective to provide crystalline domains of a size and distribution effective to provide shape memory to the shape memory composition; deforming the heated article to form a second shape; and cooling the article, while maintaining the second shape, to a temperature below the shape memory critical temperature.

Programmed shape memory articles prepared by the above method are also described.

Various other features, aspects and advantages of the present disclosure will become more apparent with reference to the following description, examples, and appended claims.

### BRIEF DESCRIPTION OF THE DRAWINGS

FIG. 1 shows several differential scanning calorimetry (DSC) traces that illustrate the effect of varying zinc oleate (ZnOl) concentration on the melting range of a shape memory polymer composition.

FIG. 2 shows several thermogravimetric analysis (TGA) traces that illustrate the effect of ZnOl concentration on the weight loss of a shape memory polymer composition.

FIG. 3 shows the effect of ZnOl concentration on stress-strain curves of a shape memory polymer composition.

FIG. 4 illustrates the effect of ZnOl concentration on softness and shape recovery of an S-EPDM.

FIG. 5 illustrates the shape memory behavior of a composite of 76.9 weight percent sulfonated poly(ethylene-co-propylene-co-ethylidene norbornene) with 30 milliequivalents sulfonate/100 grams polymer and 23.1 weight percent zinc stearate (SEPDM-ZnSt).

FIG. 6 illustrates the fill factor model.

FIG. 7 is a graph showing the effect of ZnOl concentration on the percent recovery of a shape memory polymer composition.

FIG. 8 illustrates the orientation shown in small angle X-ray scattering of a shape memory polymer composition comprising 20 weight percent ZnOl.

FIG. 9 illustrates the thermal analysis of four fatty acid-filled SEPDMs.

FIG. 10 illustrates the shape memory characteristics four fatty acid-filled SEPDMs.

FIG. 11 is a photograph of a shape memory article in (a) permanent shape, as compression molded, (b) temporary shape, after heating to 100° C., stretching, and cooling to room temperature under stress, and (c) recovered shape after heating temporary shape to 100° C. without external stress; the dotted lines represent the original length of the permanent shape; the length recovery was 92%.

FIG. 12 consists of temperature-strain (left) and temperature-strain-stress (right) views of a shape memory cycle for a composite film of Zn-SEPDM containing 23.1 weight percent ZnSt.

### DETAILED DESCRIPTION OF THE INVENTION

The present inventors have discovered that shape memory polymer compositions can be obtained using specific combinations of elastomeric ionomers and low molecular weight compounds, in particular fatty acids and/or fatty acid salts (collectively, “FAS”), amines, or amides, phosphates or similar polar, low molecular weight crystalline compounds. Low molecular weight crystalline compounds comprising 6 8 to 36 carbons, preferably 8 to 23 carbons, are particularly useful. The types and relative amounts of ionomer and low molecular weight compound are selected to provide the composition with crystalline domains of the low molecular weight crystalline compound of a size and/or distribution effective to provide shape memory to the composition. It has been found the T_{c} of the shape memory polymer composition can be adjusted by selection of an appropriate type and amount of low molecular weight crystalline compound. This property is especially useful when designing applications for the shape memory polymer compositions.

Without being bound by theory, it is believed that the permanent network in the shape memory polymer compositions is provided by the elastomeric ionomer, in particular by association of the ionic groups, which, due to unfavorable interactions between the ionic and non-ionic groups, produces nanophase separation of the ionic species. These physical crosslinks provide a permanent shape to the elastomer. Further without being bound by theory, it is believed that the polar interactions between the ionomeric elastomer and the low molecular weight crystalline compound stabilize the dispersion of the low molecular weight crystalline compound in the polymer and provide the continuity between the phases that allows the crystals of the low molecular weight crystalline compound to provide a temporary network of physical crosslinks. In some embodiments, the shape memory polymer composition is in the form of one or more bi-layers of the ionomeric elastomer and the low molecular weight additive. The inventors are unaware of any disclosure of shape memory polymers where low molecular weight crystalline additives are used to provide the temporary network. This feature allows for the tunability of the shape memory polymer properties with the use of different low molecular weight crystalline compounds and their unique triggering melting points.

A wide variety of elastomeric ionomers can be used in the compositions, including thermoplastic ionomers. Thermoplastic ionomers have the unique property of forming reversible crosslinks. At melt processing temperatures, crosslinks disassociate to later reform as the material cools to its glass transition temperature. The ionomers can be in the form of a solid or a foam. Ionomeric foams are described, for example, in U.S. Pat. No. 4,186,163 to Brenner et al., U.S. Pat. No. 4,053,548 to Lundberg et al., and U.S. Pat. No. 3,870,662 to Lundberg.

Elastomeric ionomers are predominantly hydrophobic polymers that contain a small amount of covalently bonded anionic groups. Suitable anionic groups include, for example, carboxylic acids, phosphonic acids, sulfonic acids, amines that form anions, thioglycolic acids, and the like. The ionic groups can be incorporated into the hydrophobic backbone of the polymer by derivatization of the polymer, or by incorporation of monomer units comprising the ionic groups during polymerization. In general, the units comprising the ionic groups are present in amounts of less than 25 mole %, less than 15 mole %, or less than 10 mole % of the total units in the polymer. The elastomeric ionomer can be either non-crosslinked or covalently crosslinked. The former has the advantage that it can be thermally formed into shape by heat and stress as in a typical polymer processing operation. Ionomers containing bonded cations, including, for example, ammonium (example, pyridinium) or phosphonium groups can also be used in the instant invention.

The polymeric elastomer typically has a room temperature modulus of about 10⁴ to about 10⁷ pascals (Pa). Exemplary elastomers that can be used as the elastomeric ionomer include sulfonated, carboxylated and/or phosphonated rubbers derived from ethylene-propylene rubber (EPM), ethylene-propylene-diene monomer ternary copolymers (EPDM), poly(isoprene), poly(butadiene), styrene-diene random or block copolymers (wherein the dienes can be isoprene, butadiene, or substituted analogs), for example styrene-butadiene rubber (SBR), hydrogenated styrene-diene copolymers, poly(norbornene), styrene-olefin random or block copolymers wherein the olefins can be ethylene, propylene, isobutylene and the like, epoxidized natural rubber, chloroprene rubber (CR), nitrile-butadiene rubber (NBR), hydrogenated nitrile-butadiene rubber (HNBR), the poly(glycol methacrylate) and hydroxyethyl methacrylate-stearyl methacrylate copolymer rubbers available under the trade name “HYDRON,” epichlorohydrin rubber (ECO), natural rubber, epoxidized natural rubber, butyl rubber, polyether rubber, silicone rubber, fluorosilicone rubber, fluorinated rubber, fluorinated ether rubber, chlorinated polyethylene rubber, acrylic rubber, polysulfide rubber, and urethane rubber. A combination of different ionic elastomers can be used.

A specific exemplary elastomeric ionomer useful in the preparation of the shape memory polymer is a sulfonated rubber derived from an olefinic polymer such as EPDM. EPDM is a terpolymer derived from copolymerization of ethylene, propylene, and a diene monomer. The diene monomer can be a non-conjugated diene monomer such as 1,4-hexadiene, dicyclopentadiene, 5-ethylidiene-2-norbornene, 5-methylene-2-norbornene, 5-propenyl-2-norbornene, and methyl tetrahydroindene. In general, EPDM has a low degree of unsaturation, for example, about 1 to about 10 weight percent (wt. %) olefinic unsaturation, more preferably about 2 to 8 weight percent most preferably about 3 to about 7 weight percent olefinic unsaturation. Methods for producing these terpolymers are generally known in the art. Useful terpolymers can comprise about 40 to about 80 weight percent, more specifically 45 to about 75 weight percent, units derived from ethylene; about 1 to about 10 weight percent, more specifically about 2.6 to about 8 weight percent, of units derived from the nonconjugated diene monomer; and the balance of the polymer being derived from propylene. A specific EPDM contains 52 weight percent of units derived from ethylene, 43 weight percent of units derived from propylene, and 5 weight percent of units derived from ethylidene-norbornene, and has a Mooney viscosity of 20 at 25° C.

The olefinic polymer, e.g., EPDM, can be sulfonated after polymerization as described in more detail in the Examples below. Generally, the olefinic polymer is dissolved in a suitable solvent, for example, an aromatic hydrocarbon, an aliphatic hydrocarbon, or a halogenated aromatic hydrocarbon, and reacted with the sulfonating agent such as acetyl sulfate at a temperature of −100° C. to +100° C. The sulfonating agent is preferably dissolved and added in a suitable solvent, or sulfonation can be done as a melt, for example using reactive extrusion. Once the sulfonation is complete, the reaction is quenched, for example by the addition of an aliphatic alcohol.

Carboxylated ionomers are also useful in the preparation of the shape memory polymer compositions. Carboxylated ionomers can be derived from polymeric materials having olefinic unsaturation, such as an adduct of maleic anhydride and EPDM.

Phosphonated ionomers can also be used, for example ionomers containing units derived from one or more polymerizable olefins containing 2 to 12 carbon atoms, such as ethylene, propylene, 1-butene, isobutene, 1-hexene, and 2-ethyl-1-hexene, conjugated dienes such as butadiene or isoprene, and non-conjugated dienes such as 1,4-hexadiene and 5-ethylidenenorbornene. Examples of the polymers include polyethylenes, EPR, diene rubbers, EPDM rubbers. The polymers can be phosphonated by means known in the art.

The number of anionic groups in the ionomeric elastomer can vary, depending on the desired properties of the ionomeric elastomer. For example, the elastomer can have about 0.1 to about 1000 milliequivalents of anionic groups per 100 grams of ionomeric elastomer, more specifically about 1 to about 100 milliequivalents of anionic groups per 100 g of ionomeric elastomer. In one embodiment the ionomeric elastomer is an EPDM sulfonated to provide about 1 to about 50 milliequivalents of sulfonic acid groups per 100 grams of ionomeric elastomer (meq SO₃H/100 g of elastomer), more specifically about 5 to about 40 meq SO₃H/100 g of elastomer, or even more specifically about 20 to about 35 meq SO₃H/100 g of elastomer. This value is readily determined by elemental sulfur analysis or by titration of the acid form of the polymer.

The salt form of the ionomeric elastomers can be used to produce the shape memory polymer compositions. The salt forms can be obtained by known methods, for example the reaction of the acid form of the ionomer with a neutralizing agent such as a monovalent or divalent metal salt of a weak carboxylic acid. Suitable neutralizing reagents include metallic salts of C₁₋₂₀ alkoxides, C₁₋₂₀ alkanoates, and combinations thereof, wherein the metallic ion of the metallic salt is from Groups IA, IIA, IB, IIB, IIIA, IVA, and VIII of the Periodic Table of Elements. See page B-3, Handbook of Chemistry and Physics, Chemical Rubber Publishing Co., 47th Ed. Suitable monovalent metal ions include Na⁺, K⁺, Li⁺, Cs⁺, Ag⁺, Hg⁺, and Cu⁺. Suitable divalent metal ions include Be⁺², Mg⁺², Ca⁺², Sr⁺², Ba⁺², Cu⁺², Cd⁺², Hg⁺², Sn⁺², Fe⁺², Pb⁺², Co⁺², Ni⁺², and Zn⁺². Other neutralizing agents are metallic oxides or hydroxides wherein the metallic ion is from Groups IA, IIA, IIB, and IVA of the Periodic Table of Elements. Illustrative examples are lead oxide, zinc oxide, calcium oxide, magnesium oxide, sodium hydroxide, magnesium hydroxide, calcium hydroxide, and sodium ethoxide. Still other useful neutralizing agents are ammonia and primary, secondary, and tertiary amines having up to 30 carbons.

Polymers containing unsaturation and anionic groups tend to be less thermostable, and it is therefore desirable to neutralize the anionic groups as part of the manufacturing of the ionomeric elastomers. Neutralization further improves the physical properties of the ionomeric elastomers. Although the preparation of the ionomeric elastomer does not require complete anionic group neutralization, in one embodiment, enough base is added to theoretically neutralize at least about 80% of the anionic groups, more specifically at least about 90%, and most specifically at least about 99% of the anionic groups.

The low molecular weight additive has a molecular weight of about 125 to about 750 Daltons (or grams/mole), specifically about 150 to about 500 Daltons. The low molecular weight additive forms crystalline, micrometer- and/or nanometer-sized domains in the shape memory polymer composition. Suitable compounds generally have a melting point of greater than about 25° C., specifically greater than about 30° C. Such compounds are preferably crystalline, and have a melting point of less than about 200° C., specifically less than about 130° C.

The low molecular weight compounds are also selected so as to be compatible with the ionomer. In an advantageous feature of the present composition, the anionic groups of the ionomer stabilize the crystalline dispersions of the low molecular weight compound. For example, a compound such as zinc stearate readily blooms (i.e., phase separates and exudes) from elastomers such as EPDM at a concentration of less than 1 weight percent. Here, appropriate selection of the ionomer and the low molecular weight compound provides compositions that are clear and do not bloom over time, even at high concentrations of low molecular weight compound.

The low molecular weight compound can be an amine, an amide, a fatty acid, and/or fatty acid salt. Suitable amines can be straight chain, cyclic, branched chain, or a mixture thereof, and saturated, monounsaturated, polyunsaturated, or aromatic, and can have from 8 to 36 carbon atoms, preferably 8 to 23 carbon atoms. Monoamines, diamines, triamines, or higher amines can be used. Suitable amides can be straight, cyclic, branched chain, or mixture thereof, and saturated, monounsaturated, polyunsaturated, or aromatic, and can have from 8 to 36 carbon atoms, preferably 8 to 23 carbon atoms. Monoamides, diamides, triamides, or higher amides can be used.

The fatty acid can be straight or branched chain, and saturated, monounsaturated, or polyunsaturated aliphatic carboxylic acids having from 8 to 36 carbon atoms, specifically 8 to 30 carbon atoms. Fatty acids containing, 1, 2, 3, or more than three carboxylic acid or carboxylate groups can be used. In one embodiment, the fatty acid is a straight chain, unsaturated or monounsaturated carboxylic acid having from 8 to 21 carbon atoms, in particular lauric, myristic, palmitic, stearic, or oleic acid. The acids or the corresponding cation salts of the acids can be used. Suitable cations include elements of Groups IA, IIA, IB, or IIB of the Periodic Table of Elements. Of these, zinc, magnesium, and calcium can be specifically mentioned, for example zinc stearate. A combination of cations can be used. Fatty acids and fatty acids salts are known additives in polymer compositions, as described, for example, in European Patent Application No. 1,457,305 A1 of Murakami et al., and in U.S. Pat. No. 4,193,899 to Brenner et al. However, such additives are used as plasticizers or processing aids, and the amounts added are insufficient to provide the polymers with good shape memory properties. Furthermore, as described above, a feature of the present composition is that the low molecular weight compound exists as crystalline, micrometer- and/or nanometer-sized domains within the ionomeric elastomer matrix.

The relative amount of ionomer and low molecular weight crystalline compound will vary depending on the type of ionomer and low molecular weight crystalline compound, and the desired properties of the shape memory polymer composition. The amounts of ionomer and low molecular weight crystalline compound are selected to provide a primary and secondary network structure effective to confer shape memory properties to the composition. In one embodiment, the shape memory polymer composition comprises about 25 to 90 weight percent of the ionomeric elastomer and 10 to 75 weight percent of the low molecular weight crystalline compound, specifically 60 to 90 weight percent of the ionomer and 10 to 40 weight percent of the low molecular weight crystalline compound, and even more specifically 70 to 80 weight percent of the ionomer, and 20 to 30 weight percent of the low molecular weight crystalline compound.

Other additives known for use in shape memory polymer compositions can also be present in amounts normally used, for example, particulate fillers, colorants, UV absorbers, IR absorbers, gamma ray absorbers, antioxidants, flame retardants, thermal stabilizers, mold release agents, lubricants, plasticizers, and the like.

The shape memory polymer compositions are prepared by combining the ionomeric elastomer with the low molecular weight crystalline compound. The mixing can be by a variety of means, for example melt blending. The ability to use melt processes is advantageous from a commercial standpoint, as solvents are not required. The shape memory compositions can then be molded into the desired permanent shape. Solution mixing, for example, at room temperature can also be used. Suitable solvents are effective to dissolve each of the components, do not significantly react with the components, and can readily be removed from the mixture, for example by evaporation.

The order of addition of the components does not appear to be critical. In one embodiment, the shape memory polymer composition is covalently crosslinked after formation by known processes. For example, the compositions can be crosslinked by a chemical crosslinking agent such as sulfur, a sulfur compound, a peroxide or the like, or by irradiation with an ionizing radiation such as a gamma ray or an electron beam, or by heating alone. Crosslinked compositions can be less susceptible to creep and hysteresis in the transitioning between permanent and temporary shapes.

The shape memory polymer compositions described herein have a number of advantages. The elastomer compositions are readily manufactured using known methods and materials, and they are easy to shape and program. The shape memory properties are very good, with the shape memory recovery (after a cycle comprising heating to above T_{c}, deforming by application of a stress, cooling to below T_{c}, removing the stress, and reheating to above T_{c} to return the sample to its original shape) of greater than 90%, specifically greater than 92%, more specifically greater than 95%, and even more specifically greater than 98%.

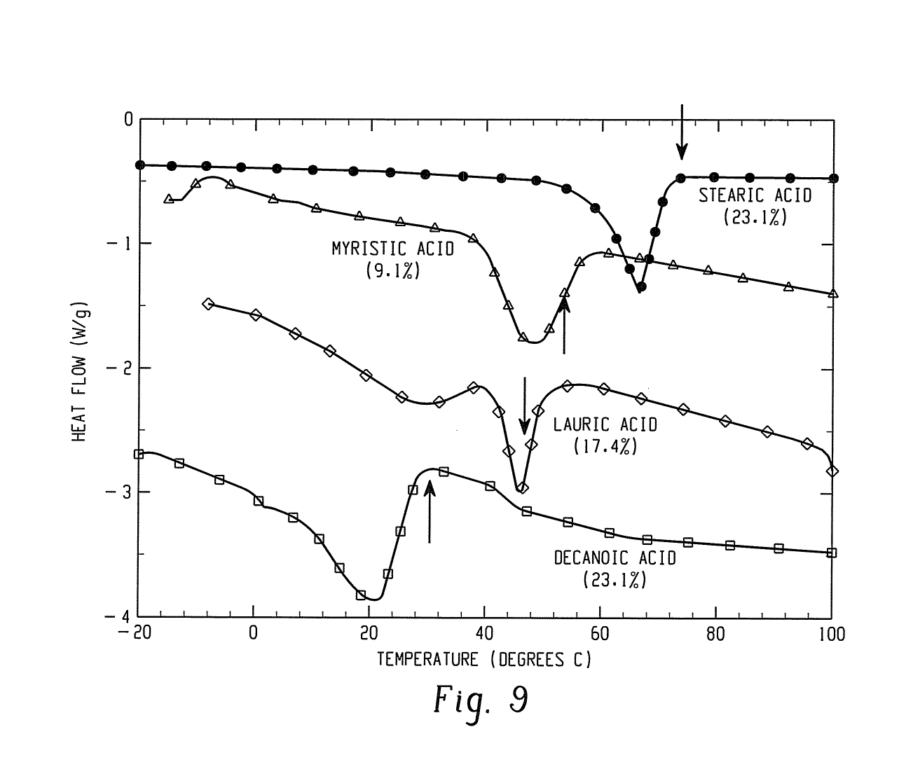

Further, changing the composition and/or amount of the low molecular weight additive allows adjustment of the elastic modulus, transition temperatures, and/or mechanical properties of the shape memory polymer compositions, as well as maximizing the shape memory properties, including shape fixation, recovery, and fill factor. In particular, it has been found that the T_{c} of the shape memory polymers can be adjusted by varying the identity of the low molecular weight crystalline compound. In most shape memory polymers, the T_{c} of the polymer is either the glass transition temperature (T_{g}) or melt temperature (Tₘ) of the polymer. Accordingly, adjusting the T_{c} of most shape memory polymers requires design and synthesis of a new polymer. However, as shown in FIG. 9, it was found that the relative T_{c} of the shape memory polymer compositions corresponds to the melting temperature, Tₘ, of the fatty acid used to prepare the composition. Furthermore, the melting point of the fatty acid determines the fixing temperature obtainable in the shape memory polymer composition. Thus, only a single ionomeric elastomer needs to be synthesized to cover a range of shape memory behavior between 0 and 200° C., specifically 25 to 130° C., more specifically 28 to 128° C.

The shape memory polymer compositions described herein are useful in applications as diverse as shrink wrapping and shrink tubing, thermally activated snap fittings, components for medical devices (for example, as orthodontic wires, stents with drug delivery capabilities, drug delivery matrices, patches and implants, surgical tools, artificial muscles, self-tightening sutures, catheters, screws, pins, plates, and biodegradable implants), self-healing plastics, impression material (for example, for molding, rapid prototyping, and dentistry), films, coatings, adhesives, rheological modifiers for paints and other products, toys, actuators, sensors, switches, heat-controlled fasteners, clothing and textiles including wrinkle-free textiles, thermally reversible recording, reversible embossing for information storage, and self-deployable structures. In a specific embodiment, the shape memory polymer compositions are used as or in medical devices.

One embodiment is a method of programming a shape memory article, comprising: heating an article having a first shape and comprising a shape memory composition to a temperature above a shape memory critical temperature of the shape memory composition; wherein the shape memory composition comprises an ionomeric elastomer, and a low molecular weight additive that forms crystalline domains in the elastomeric ionomer, wherein the amount of additive is effective to provide crystalline domains of a size and distribution effective to provide shape memory to the composition; deforming the heated article to form a second shape; and cooling the article, while maintaining the second shape, to a temperature below the shape memory critical temperature.

Another embodiment is a method of programming and deploying a shape memory article, comprising: heating an article having a first shape and comprising a shape memory composition to a temperature above a shape memory critical temperature of the shape memory composition; wherein the shape memory composition comprises an ionomeric elastomer, and a low molecular weight additive that forms crystalline domains in the elastomeric ionomer, wherein the amount of additive is effective to provide crystalline domains of a size and distribution effective to provide shape memory to the composition; deforming the heated article to form a second shape; cooling the article, while maintaining the second shape, to a temperature below the shape memory critical temperature to fix the second shape; and heating the article having the fixed second shape to a temperature above the shape memory critical temperature, thereby restoring the first shape of the article.

The SMP compositions and articles are further illustrated by the following non-limiting examples.

### EXAMPLES

In the following examples, transition temperatures were measured by differential scanning calorimetry using a TA Instruments differential scanning calorimeter, aluminum pans, and cooling and heating rates of 10° C./minute. The melting temperatures are reported as the peak temperature (maximum rate of melting).

Thermal gravimetric analysis (TA Instruments) was used to assess the thermal stability of compounds in a nitrogen atmosphere, using a heating rate of 10° C./minute.

Mechanical properties were measured with an Instron universal testing machine (10 pound load cell). Each sample was cut into a dog-bone shape with the straight portion of the samples having dimensions of 8.8 millimeters×3.3 millimeters×0.6 millimeters and mounted into the instrument using pneumatic side acting clamps. The samples were tested using an elongation rate of 5 millimeters/minute, unless otherwise noted. The shape memory properties, fixation and recovery, as well as modulus at elevated temperatures were measure using a TA dynamic mechanical thermal analyzer. Samples were placed in a thin film tension grip and heated to 100° C. After thermal equilibrium was reached, the force was ramped to 0.050 Newton and quenched to 50° C. to fix the temporary shape. The force was then decreased to 0.005 Newton to maintain tension, reheated at 2° C./min to 100° C. and held at constant force for 30 minutes to allow for any strain recovery. Dynamic mechanical thermal analysis (DMTA) was also used to measure glass transition temperature, T_{g}, by ramping the temperature from −100° C. to 250° C. at 10° C./minute.

The molecular and structural orientations of shape-fixed and shape-recovered samples were measured by small and wide angle x-ray scatterings. WAXS was conducted on a Bruker GADDS with CuKα radiation and an exposure time of 20 minutes. Small angle x-ray scattering was performed with CuKα radiation and an exposure time of 10 minutes.

Thermal analysis testing is based on the melting point endotherm of a substance in a differential scanning calorimetry (DSC) method. For the ionomer/FAS SMP, Tₛ=Tₘ(FAS) as the typical transition temperature. The results are expressed as melting ranges and can be used to evaluate various acids and concentrations of a specific acid in an ionomer/FAS SMP.

### Example 1

### Preparation of Zn-Sepdm/Znol Shape Memory Polymers

Ethylene-propylene-diene terpolymer containing 52 weight percent ethylene, 43 weight percent propylene and 5 weight percent ethylene-norbornene (Mooney viscosity=20 at 25° C., Exxon Chemical Co.) was sulfonated with acetyl sulfate to about 30 milliequivalents per 100 grams of polymer, to provide the sulfonated elastomer (SEPDM). The sulfonic acid groups were then neutralized completely to the zinc salt to provide the ionomeric elastomer (Zn-SEPDM). Ionomer/ZnOl compounds with ZnOl concentrations ranging from 0 to 50 wt. % were prepared by solution mixing in a 95/5 (volume/volume) mixture of toluene and methanol. The compounds were isolated by evaporating the solvents, and washed with boiling water and then with methanol in a blender for 60 seconds. The samples were then dried overnight in a vacuum oven at 50° C.

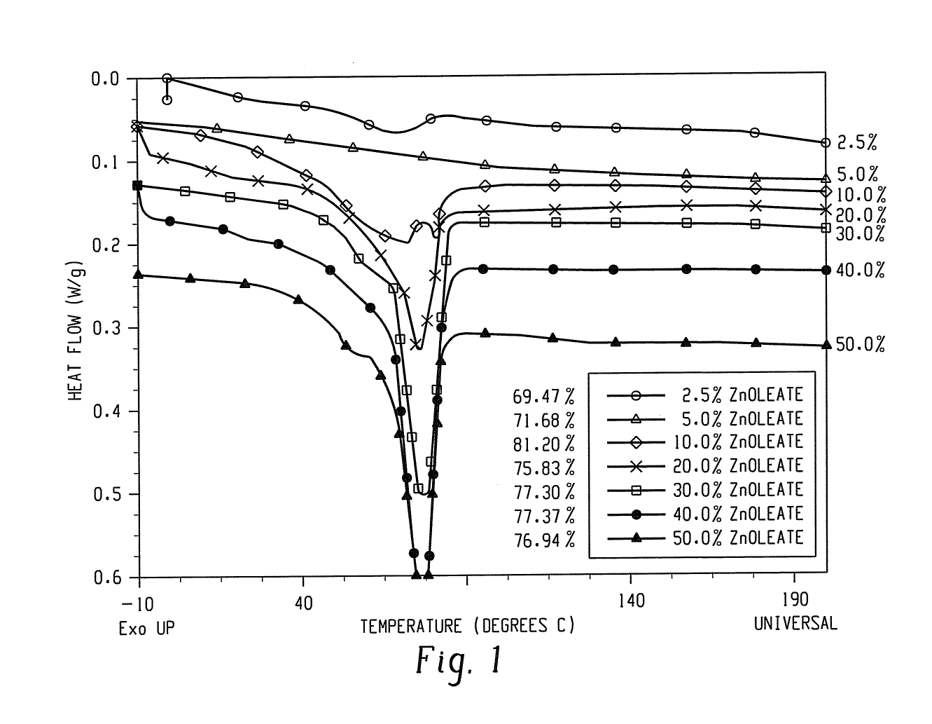

For these shape memory polymers, as shown in FIG. 1, the Tₘ of the shape memory polymer composition was depressed compared to the Tₘ of pure ZnOl (88° C.) but approached the Tₘ of pure ZnOl as the concentration of ZnOl in the elastomer composition increased. The depression of Tₘ is an indicator of the strong interactions between the ionomer and the ZnOl. For all shape memory polymer compositions comprising ZnOl, the melting range was between 65 and 80° C.

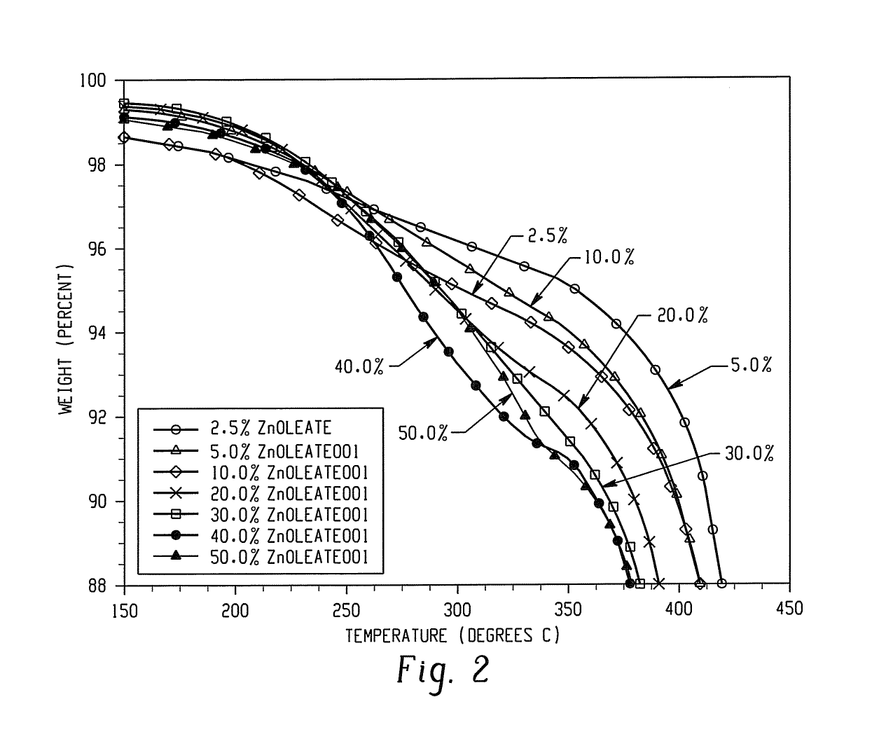

TGA was used to determine whether the addition of a fatty acid salt affected the degradation temperatures of the shape memory polymer compositions. The TGA scans were run from room temperature to 600° C. or until no processing could be done at temperatures up to 200° C. without significant degradation. At 200° C., the ZnOl began to degrade. The polymers, however, were relatively stable to 375° C. (FIG. 2). The only material remaining at the end of each test was the zinc.

DMTA indicated that the T_{g} of the Zn-SEPDM was insensitive to ZnOl concentration; the T_{g} was about −51° C. In addition, the softening temperature of the sample measures by DMTA were consistent with the Tₘ of the fatty acid salt obtained from the DSC.

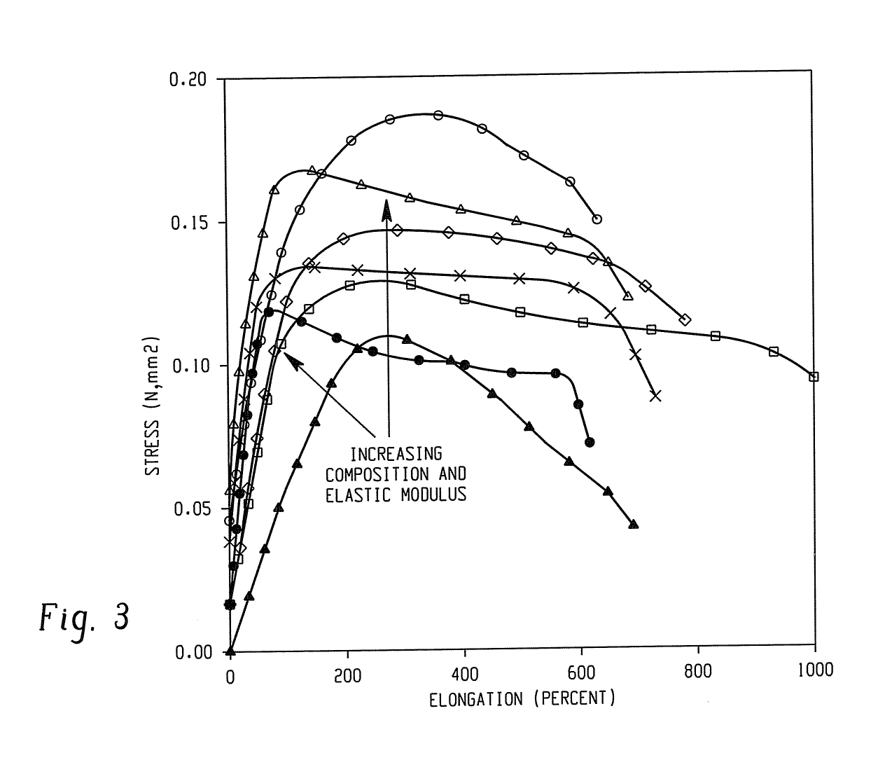

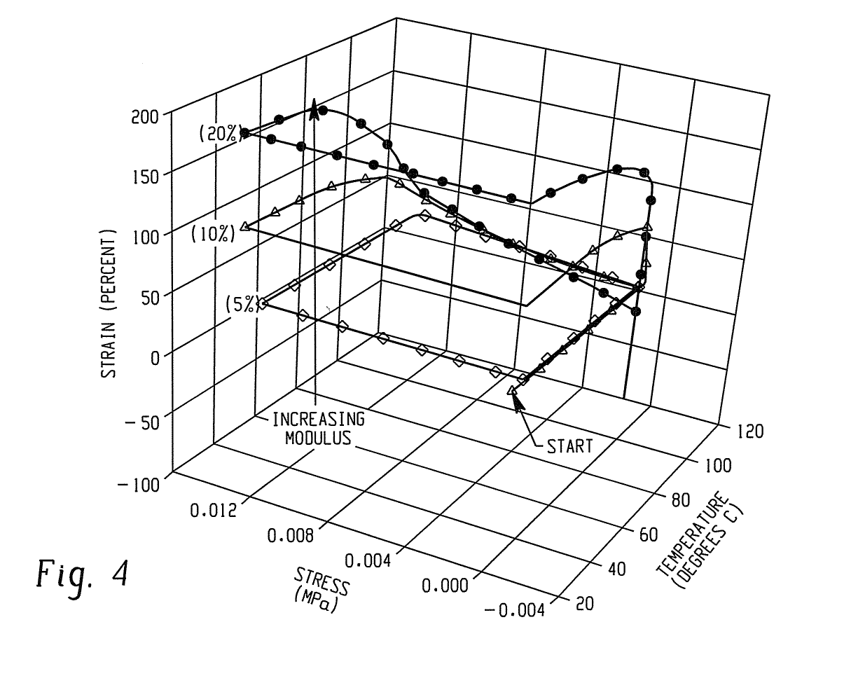

Typical stress-strain curves for the shape memory polymer compositions as a function of ZnOl concentration are shown in FIG. 3. A secant elastic modulus was defined at 2% elongation offset. As the concentrations of ZnOl increased, so did the elastic modulus, indicating that the fatty acid salt acted as reinforcing filler below Tₛ. FIG. 4 shows the effect of ZnOl concentration (5, 10, and 20 weight percent) on softness and shape recovery.

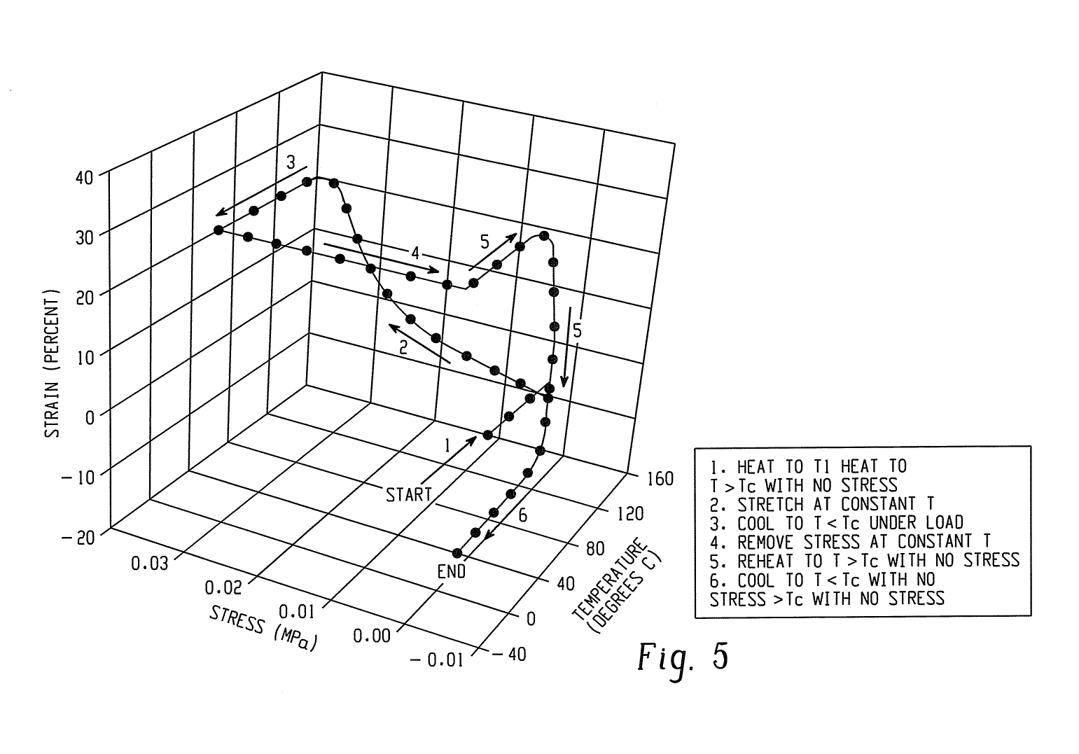

FIG. 5 illustrates the shape memory behavior of a shape memory polymer composition comprising Zn-EPDM (30 meq sulfonate/100 g polymer) and 23.1 weight percent zinc stearate. Step 1 is heating to a temperature greater than the critical temperature with no stress; Step 2 is stretching at constant temperature; Step 3 is cooling to a temperature below the critical temperature under stress; Step 4 is removing stress at constant temperature; Step 5 is heating to a temperature greater than the critical temperature with no stress; and Step 6 is cooling to a temperature below the critical temperature with no stress.

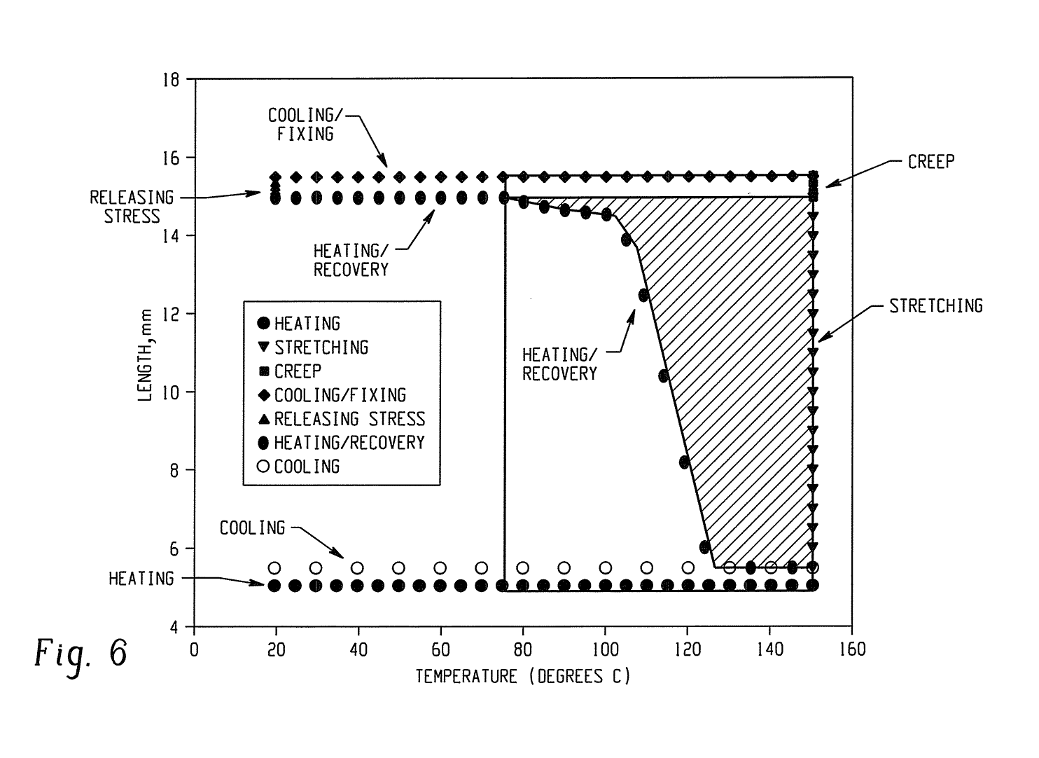

The DMTA was primarily used to test the shape memory cycle and to quantitatively compare each sample by calculating a percent fixation, percent recovery and fill factor. It was found that as the concentration of ZnOl increased, the percent recovery decreased, and the percent fixation showed no particular trend. The fill factor is a number between 0 and 1 that can be used to compare the shape memory performance, based on how well the material fixes and how fast it recovers when heated above T_{c}, wherein “1” is perfect shape memory, where the shape completely recovers at Tₛ. The fill factor is calculated from the area under the actual recovery curve divided by the ideal response represented by the rectangular box shown in FIG. 6. It was found that as the concentration of ZnOl increased, the fill factor decreased.

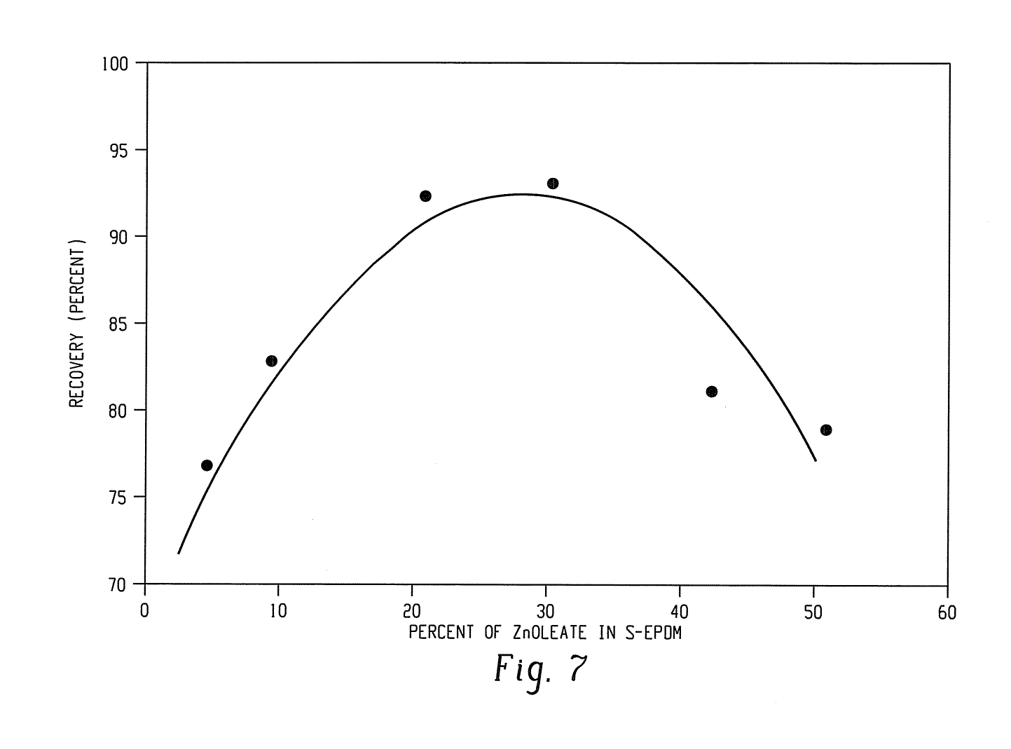

The shape memory of the elastomer composition was also tested quantitatively by submerging a straight bar sample in boiling water to melt the ZnOl network, stretching the sample with two forceps, and then quenching the sample in ice water to form a secondary shape. The samples were placed next to a ruler to be measured before fixation, after fixation, and after recovery. The recovery trend appears to be a bell shaped curve, shown in FIG. 7, with almost complete recovery for compositions containing of 20 to 30 weight percent ZnOl, and lower recovery for compositions outside of these ranges. Without being bound by theory, it is believed that poor recovery in the low ZnOl compositions is due to weaker ionic interaction between the ionomer and the fatty acid salt; and poor recovery at higher ZnOl concentrations may be due to ionic dissociation.

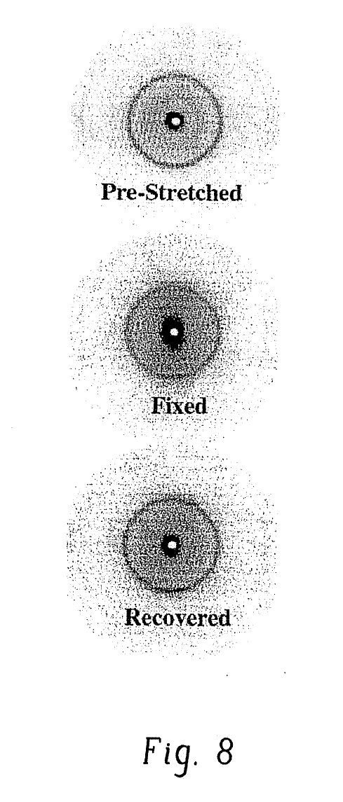

Small Angle X-Ray Scattering was performed on all samples. There was found to be no orientation in the pre-stretched and recovered samples; however, there is definite orientation of the fixed sample, indicated by the darker regions in FIG. 8, which was obtained for a shape memory polymer composition comprising 20 weight percent ZnOl. Most samples were consistent with these results; however a few of samples that did not recover completely still showed some orientation. There was no trend in the percent orientation for the different compositions of ZnOl.

After performing WAXS on all the samples, the results showed that as the concentration of ZnOl increased, so did the intensity of the rings, leading to larger peaks, when graphed versus 2 theta. The large second peak is at 41 Angstroms, which is twice the length of a single ZnOl molecule. This indicates that the sample creates bi-layers of Zn-SEPDM and ZnOl, allowing this class to work as a shape memory polymer.

### Example 2

### Preparation of Zn-Sepdm/Zn-Alkanoate Shape Memory Polymers

Using the general procedure of Example 1, Zn-SEPDM/Zn-alkanoate shape memory polymers are formed using the fatty acids shown in Table 1. The melting points of certain of the Zn-SEPDM/Zn-alkanoate shape memory polymers are shown in Table 1.

TABLE 1

| | Melting Point | Melting Point (° C.) of shape |
|---|---|---|
| Acid or Salt | (° C.) of acid | memory polymer composition |
| Decanoic acid | 31 | 28 |
| Lauric acid | 44 | 58 |
| Myristic acid | 54 | 40 |
| Pentadecanoic | 52 | |
| acid | | |
| Palmitic acid | 62 | |
| Stearic acid | 70 | |
| Arachidic acid | 75 | |
| Behenic acid | 81 | |
| Lignoceric acid | 85 | |
| Zinc stearate | 130 | 126 |

FIG. 9 shows the melting behavior of several different of Zn-SEPDM/Zn-alkanoates derived from different fatty acids. The melting points of the fatty acids in the shape memory polymers were depressed from that of the pure fatty acid compound, as a result of the strong interactions between the polymer and the fatty acid. It was found that the relative T_{c} of the shape memory polymers corresponded to the Tₘ of the fatty acid used to prepare the shape memory polymer. Furthermore, the melting point of the fatty acid determines the fixing temperature obtainable in the shape memory polymer. Thus, only a single ionomer needs to be synthesized to cover a range of shape memory behavior between 0 and 90° C.

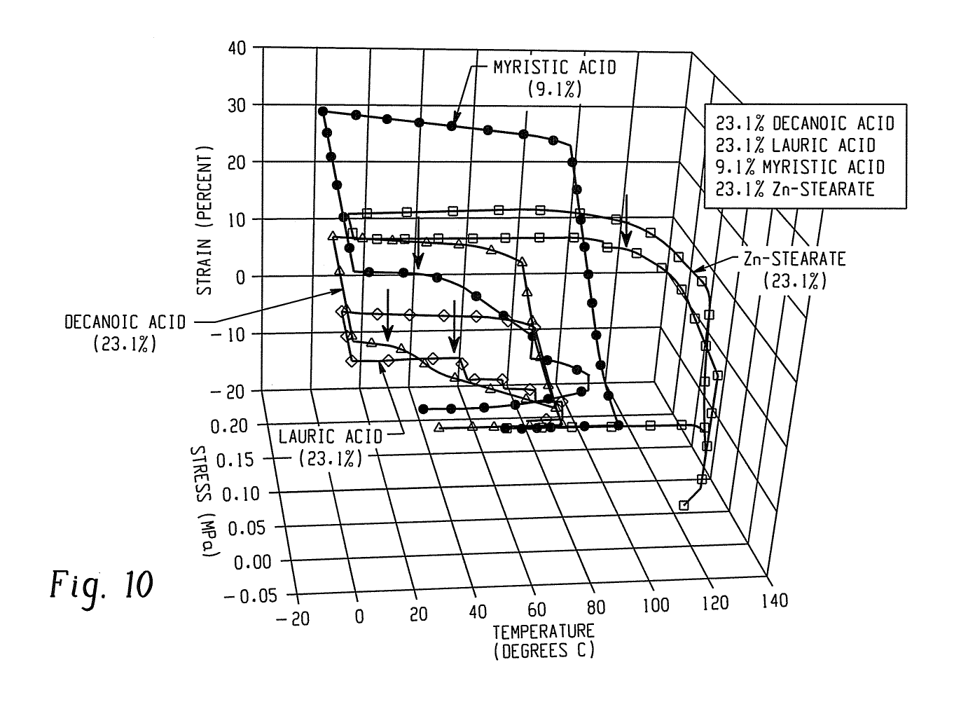

FIG. 10 illustrates the shape memory characteristics several of Zn-SEPDM/Zn-alkanoates derived from different fatty acids.

### Example 3

### Preparation of Zn-Sepdm/Zn-Alkanoate Shape Memory Polymers

Poly{ethylene-r-propylene-r-(5-ethylidene-2-norbornene [ENB])}, EPDM (Royalene 521: Mooney viscosity=40 (ML (1+4)/100° C.) and composition of 49% ethylene, 46% propylene, and 5% ENB) was obtained from Crompton Chemical Co. The zinc salt of sulfonated EPDM (ionomer) with a zinc sulfonate concentration of 0.03 meq/g was prepared by sulfonating EPDM with acetyl sulfate and neutralizing the product with zinc acetate.¹¹ Zinc stearate (ZnSt)/ionomer composites were prepared by dispersing the ZnSt in a solution of the ionomer, flashing off the solvent with steam and drying. Film samples were compression molded at 200° C. Shape memory cycles to assess fixation and recovery of the SMPs were measured with a TA Instruments Dynamic Mechanical Thermal Analyzer (DMTA) 2980 using the tension mode and a frequency of 1 Hz.

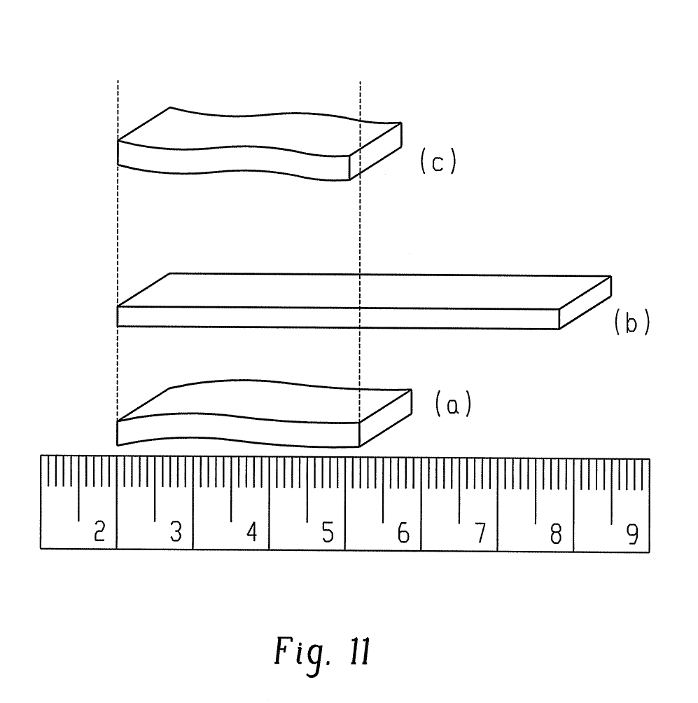

FIG. 11 shows the shape memory characteristics of a ZnSt/ionomer composite containing 33.3 weight percent ZnSt. The film (a) was heated to 100° C. and stretched to 47% strain and cooled to room temperature to fix a temporary elongated shape (b). The temporary shape was stable below 80° C., but when reheated to 100° C., the film recovered to the permanent shape (c). The length recovery was 92%.

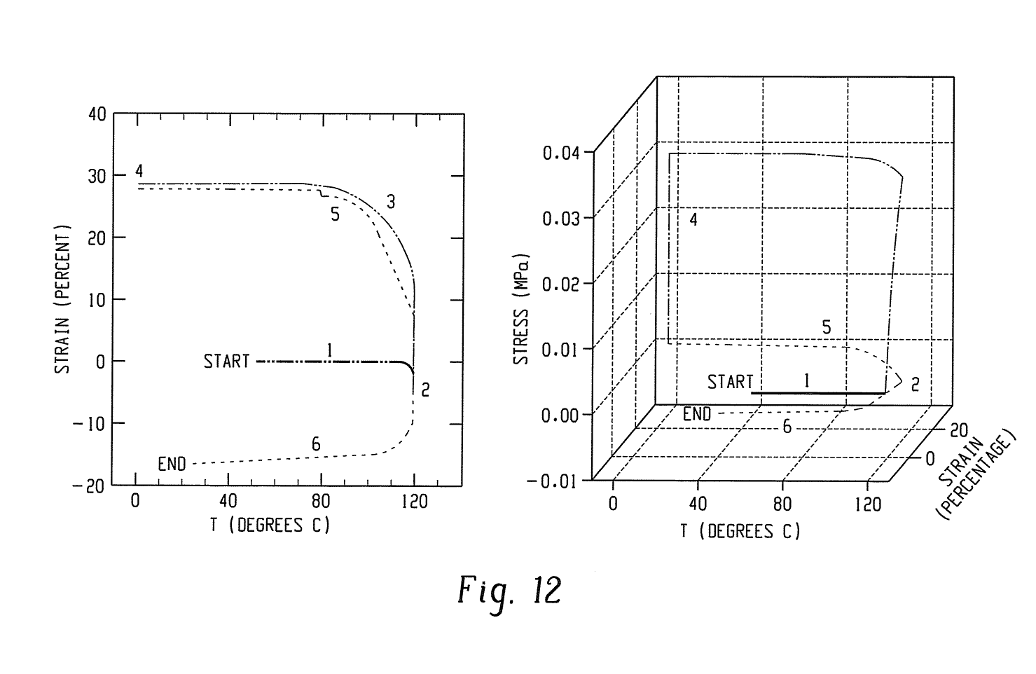

A shape memory cycle for the composite containing 33.3 weight percent ZnSt is shown in FIG. 12. The film was heated to 120° C. with a preload of 0.005 N to maintain tension (step 1) and held at 120° C. to equilibrate, during which the length shrunk to a strain of about −4% (step 2). The film was then stretched to 29% strain and cooled under load at constant strain to 0° C. (step 3). After equilibrating at constant temperature and strain, the force was reduced to 0.005 N at constant strain (step 4). Shape recovery was achieved by reheating the film at 2° C./minute (step 5). Recovery began at about 80° C. (Tₛ). After reaching 120° C., the film was cooled quickly to 50° C. (step 6).

The strain recovery in the cycle shown in FIG. 12 was >100% (see below). Tₘ of ZnSt in the composite was 120° C., which is lower than that of the pure ZnSt (about 130° C.). This was due to improved miscibility of the ZnSt in the ionomer, because of strong interactions between the sulfonate groups of the ionomer and the metal stearate groups. The melting point depression of fatty acids (salts) mixed into Zn-SEPDM are given in Table 1. The strong interaction between the ionomer and ZnSt is also supported by the observation that composites containing as much as 33 weight percent ZnSt were relatively clear, while the addition of less than 1 weight percent ZnSt to non-sulfonated EPDM produced a white, opaque sample with noticeable phase separation of the ZnSt. See Weiss, R. A., “Time dependent characteristics of sulfonated EPDM containing zinc stearate I. Thermal Behavior”, J. Appl. Polym. Sci., 1983, volume 28, pages 3321-3332.

The permanent network in these composites arises from strong intermolecular associations of the Zn-sulfonate groups in the ionomer, which produce nanophase separation of ion-rich domains that persist to >200° C. See Weiss, R. A., “Time dependent characteristics of sulfonated EPDM containing zinc stearate I. Thermal Behavior”, J. Appl. Polym. Sci., 1983, volume 28, pages 3321-3332; and Chun, Y. S.; Weiss, R. A. Weiss, “The Development of the Ionic Microphase in Sulfonated Poly(ethylene-co-propylene-co-ethylidene norbornene) Ionomers During Physical Aging”, Polymer, 2002, volume 43, pages 1915-1923. The characteristic relaxation times for the ionic aggregates in other sulfonate-ionomers were reported to be greater than five orders of magnitude greater than the relaxation time associated with the glass transition, which indicates that the physical crosslinks in these polymers should behave as permanent for the experiments described above. The temporary network is believed to be due to very small ZnSt crystals (since the samples were relatively clear, the size of the crystals must be less than about 0.5 μm) that interact strongly with the Zn-SEPDM and act as crosslinks below the softening of the ZnSt crystals (T_{c}), which corresponded to the beginning of the melting endotherm started in a DSC measurement.

The reason the final length of the SMP in the cycle shown in FIG. 12 was less than the original length is believed to be a consequence of the non-equilibrium state of the original film. The films were compression molded above the dissociation temperature of the nanophase-separated domains, >200° C. (see Jackson, D.; Koberstein, J. T.; Weiss, R. A. Small-Angle X-Ray Scattering Studies of Zinc-Stearate-Filled Sulfonated Poly(ethylene-co-propylene-co-ethylidene norbornene) Ionomers”, J. Polym. Sci., Phys. Ed., 1999, volume 37, pages 3141-3150), and because of the long relaxation times of these ionomers, it is unlikely that an equilibrium chain conformation was achieved during the molding process. Prior work indicated that significant physical aging effects occur in sulfonated poly(ethylene-co-propylene-co-ethylidene norbornene) ionomers over a time period of a month. See, Chun, Y. S.; Weiss, R. A. Weiss, “The Development of the Ionic Microphase in Sulfonated Poly(ethylene-co-propylene-co-ethylidene norbornene) Ionomers During Physical Aging”, Polymer, 2002, volume 43, pages 1915-1923. Thus, during the shape memory cycle, it is possible that aging and stretching of the sample affected the “permanent network” and changed the “equilibrium” length of the sample. Multiple tests on different samples of the same material used in FIG. 12 produced similar shape memory behavior, but differences in the final length which was always >90% of the original length.

Clearly, the lack of reproducibility of the recovered film length is troublesome for an SMP. However, the residual double bonds in the Zn-SEPDM can be covalently crosslinked during sample preparation to produce a covalently crosslinked network. Although the physical ionic associations were used for the “permanent network” in this study, the importance of the ionomer is not to provide crosslinks, but, rather, to provide the strong interactions with the FA that allow it to provide a robust physical temporary network.

These results demonstrate that the low molecular weight additive provides the temporary network, and a single elastomer can be used to create a family of SMPs with different T_{c}'s by choosing low molecular weight additives with varying melting points. T_{c}'s for other low molecular weight additive/ionomer composites measured from shape memory cycles similar to FIG. 12 are listed in Table 2. T_{c} was systematically lower than Tₘ, and these data show that with a judicious choice of FA, the Zn-SEPDM/FA composites provide a SMPs with a 70° C. range of T_{c}'s.

TABLE 2
Melting points of Fatty Acids (Salts) and Fixing Temperature
of Fatty Acid (Salt)/Zn-SEPDM Shape Memory Polymers

| | | Tₘ (° C.) | | |
|---|---|---|---|---|
| | Concentration | Neat | Fatty Acid | |
| | in compound | Fatty Acid | (Salt) in | |
| Fatty Acid (Salt) | (wt %) | (Salt) | composite | T_{c} (° C.) |
| Decanoic Acid | 23.1 | 31 | 20 | 10 |
| Lauric Acid | 23.1 | 44 | 40 | 35 |
| Myristic Acid | 9.1 | 54 | 45 | 30 |
| Magnesium Stearate | 30.0 | 87 | 71 | 67 |
| Zinc Oleate | 33.3 | 88 | 77 | 70 |
| Zinc Stearate | 33.3 | 130 | 120 | 80 |

The terms “a” and “an” do not denote a limitation of quantity, but rather denote the presence of at least one of the referenced item. Unless defined otherwise, technical and scientific terms used herein have the same meaning as is commonly understood by one of skill in the art to which this invention belongs. The modifier “about” used in connection with a quantity is inclusive of the stated value and has the meaning dictated by the context (e.g., includes the degree of error associated with measurement of the particular quantity). The endpoints of all ranges directed to the same component or property are inclusive of the endpoint and independently combinable. As used herein, “combination” is inclusive of blends, mixtures, alloys, reaction products, and the like. The disclosure of all references cited herein is incorporated by reference in their entirety.

While the disclosure has been illustrated and described in typical embodiments, it is not intended to be limited to the details shown, since various modifications and substitutions are possible without departing from the spirit of the present disclosure. As such, modifications and equivalents of the disclosure herein may occur to persons skilled in the art using no more than routine experimentation, and all such modifications and equivalents are believed to be within the spirit and scope of the disclosure as defined by the following claims.

What is claimed is:

1. A shape memory article deformable from a temporary shape to a permanent shape, the shape memory article comprising a shape memory composition comprising an ionomeric elastomer, and a low molecular weight additive that forms crystalline domains in the elastomeric ionomer, wherein the amount of additive is effective to provide crystalline domains of a size and distribution effective to provide shape memory to the shape memory composition.

2. The shape memory article of claim 1, wherein the ionomeric elastomer has a room temperature modulus of about 10⁴ to about 10⁷ Pascals.

3. The shape memory article of claim 1, wherein the ionomeric elastomer comprises a hydrophobic polymer backbone and carboxylic acid, sulfonic acid, and/or phosphonic acid groups or their corresponding salts covalently bonded to the backbone.

4. The shape memory article of claim 1, wherein the ionomeric elastomer comprises a hydrophobic polymer backbone and carboxylic acid groups and/or their corresponding salts covalently bonded to the backbone.

5. The shape memory article of claim 1, wherein the ionomeric elastomer comprises a hydrophobic polymer backbone and sulfonic acid groups and/or their corresponding salts covalently bonded to the backbone.

6. The shape memory article of claim 1, wherein the ionomeric elastomer comprises a hydrophobic polymer backbone and phosphonic acid groups and/or their corresponding salts covalently bonded to the backbone.

7. The shape memory article of claim 3, wherein the ionomeric elastomer comprises phosphonic acid salts comprising a Group IA, IIA, IB, IIB, IIIA, IVA, or VIII cation.

8. The shape memory article of claim 3, wherein the ionomeric elastomer comprises phosphonic acid salts comprising a zinc or magnesium cation.

9. The shape memory article of claim 1, wherein the ionomeric elastomer is a sulfonated olefin polymer.

10. The shape memory article of claim 1, wherein the ionomeric elastomer is a sulfonated ethylene-propylene-diene terpolymer.

11. The shape memory article of claim 1, wherein the ionomeric elastomer is a foam.

12. The shape memory article of claim 1, wherein the low molecular weight additive is crystalline and has a melting point of greater than 25° C.

13. The shape memory article of claim 1, wherein the low molecular weight additive has a molecular weight of about 125 to about 750 Daltons.

14. The shape memory article of claim 1, wherein the low molecular weight additive is a C₈₋₃₆ amine, a C₈₋₃₆ amide, a C₈₋₃₆ carboxylic acid, or a C₈₋₃₆ carboxylic acid salt.

15. The shape memory article of claim 1, wherein the low molecular weight additive is a branched or linear, saturated or monounsaturated C₈₋₂₃ carboxylic acid or a salt thereof.

16. The shape memory article of claim 15, wherein the low molecular weight additive is a salt of a branched or linear, saturated or monounsaturated C₈₋₂₃ carboxylic acid comprising a Group IA, IIA, IB, or IIB cation.

17. The shape memory article of claim 1, wherein the low molecular weight additive is a linear, saturated or monounsaturated C₈₋₂₃ carboxylic acid or a salt thereof.

18. The shape memory article of claim 17, wherein the low molecular weight additive is a salt of a linear, saturated or monounsaturated C₈₋₂₃ carboxylic acid comprising a Group IA, IIA, IB, or IIB cation.

19. The shape memory article of claim 17, wherein the salt comprises a zinc or magnesium cation.

20. The shape memory article of claim 1, wherein the shape memory composition comprises 60 to 90 weight percent of the ionomeric elastomer and 10 to 40 weight percent of the low molecular weight additive.

21. The shape memory article of claim 1, wherein the shape memory composition comprises 70 to 80 weight percent of the ionomeric elastomer and 20 to 30 weight percent of the low molecular weight additive.

22. The shape memory article of claim 1, wherein the shape memory polymer composition is in the form of one or more bi-layers of the ionomeric elastomer and the low molecular weight additive.

23. The shape memory article of claim 1, wherein the shape memory composition exhibits a critical temperature of about 25 to 130° C.

24. The shape memory article of claim 1,
wherein the shape memory composition comprises 70 to 80 weight percent of the ionomeric elastomer and 20 to 30 weight percent of the low molecular weight additive;
wherein the ionomeric elastomer is a sulfonated ethylene-propylene-diene terpolymer; and
wherein the low molecular weight additive is a linear, saturated or monounsaturated C₈₋₂₃ carboxylic acid or a salt thereof.

25. The shape memory article of claim 1, in the form of a medical device.

26. A method of programming a shape memory article, comprising:
heating an article having a first shape and comprising a shape memory composition to a temperature above a shape memory critical temperature of the shape memory composition; wherein the shape memory composition comprises an ionomeric elastomer, and a low molecular weight additive that forms crystalline domains in the elastomeric ionomer, wherein the amount of additive is effective to provide crystalline domains of a size and distribution effective to provide shape memory to the shape memory composition;
deforming the heated article to form a second shape; and
cooling the article, while maintaining the second shape, to a temperature below the shape memory critical temperature.

27. A programmed shape memory article prepared by the method of claim 26

28. The programmed shape memory article of claim 27 in the form of a medical device.
